(19) United States
(12) Patent Application Publication
(10) Pub. No.: US 2006/0114480 A1
(43) Pub. Date: Jun. 1, 2006

(54) Method of Driving a Pixel

(76) Inventors: Fung-Jane Chang, Tainan County (TW); Ling-Shiou Huang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 10/908,991

(22) Filed: Jun. 3, 2005

(30) Foreign Application Priority Data
Dec. 1, 2004 (TW) 093137063

(51) Int. Cl. G06F 15/00

(52) U.S. Cl. 358/1.9; 358/3.06

(57) ABSTRACT

A method of reducing frame buffer size for driving a pixel includes converting a first color signal at a first color space of the pixel into a second color signal at a second color space, storing the second color signal into a memory, reading the second color signal from the memory and converting the second color signal into a first color signal, and driving the pixel according to the first color signal transferred from the second color signal and a target gray level.

### BACKGROUND OF INVENTION

1. Field of the Invention

The present invention relates to a method of driving a pixel, more particularly, a method of reducing frame buffer size for driving a pixel.

2. Description of the Prior Art

The liquid crystal display (LCD) panel is characterized by lightweight, low power consumption, and low radiation. Because of these characteristics, the LCD panel is widely applied in portable electronic products such as notebook computers and personal digital assistant (PDAs). LCD monitors are so desirable that they are replacing the cathode ray tube (CRT) monitors. Liquid crystal molecules have different polarization and refraction to light due to different alignment, therefore the amount of light transmitted can be controlled to further generate light with different strengths. This is how an LCD panel displays different gray-level strengths of red, green, and blue light to produce rich images.

When an electric field is applied to liquid crystal molecules to change their alignment, a gray-level value figure of a previous frame data is first stored into a buffer to be read and compared with a gray-level value of a next frame data so that the field strength of the liquid crystal molecules can be obtained. Some non-trivial time will be required to reach the final state due to the properties of the molecules, thus causing output delay on the screen. Therefore, overdrive technology is adopted to solve the problem of low response time of an LCD. For instance, when employing an electric field with strength E1, E2, or E3, a liquid crystal molecule will turn to gray-level A1, A2, or A3, where E1<E2<E3 and A1<A2<A3. That is, a pixel turns from gray-level A1 to gray-level A2 when the LCD panel changes the electric field strength from E1 to E2. If the pixel is not overdriven, it takes a delay time for the pixel to change from gray-level A1 to gray-level A2. However, if we want to shorten the transformation time of the pixel from gray-level A1 to gray-level A2, the LCD panel may change an original electric field strength E1 to an electric field strength E3 greater than E2, raising the target gray-level of the pixel from A2 to A3, causing the liquid crystal molecule to change to the target gray-level A2 in a faster way. The overdriven transformation of the pixel is stopped once the gray-level of the pixel reaches A2. Thereby, the transformation of a pixel is sped up and the delay time of the transformation is reduced. The prior art overdrive technology utilizes a look up table (LUT) to store the needed target gray-level value of each gray-level transformation, where the target gray-level is utilized to shorten the transformation time that a pixel takes to change from a first gray-level to second gray-level on a display panel.

Please refer to FIG. 1. FIG. 1 illustrates a diagram of a conventional gray level lookup table 10. The lookup table 10 comprises a first gray-level array 12, a second gray-level array 14, and a target gray-level array 16. The first gray-level array 12 comprises a plurality of first gray-level values 17, the second gray-level array 14 comprises a plurality of second gray-level values 18, and the target gray-level array 16 comprises a plurality of target gray-level values 19. If the gray-level of a pixel of the display changes from gray-level 4 to gray-level 5, a target gray-level 7 will be obtained from the target gray-level array 16 of the lookup table 10. That is, as the pixel is changing from gray-level 4 to gray-level 5, the LCD display adjusts the electric field applied to the pixel from the strength corresponding to gray-level 4 to the strength corresponding to gray-level 7 instead of to the strength of gray-level 5, and stops the gray-level change of the pixel when it reaches gray-level 5. Likewise, a pixel from gray-level 6 to gray-level 3 can be adjusted according to a target gray-level 0 referencing the target gray-level array 16 of the lookup table 10 to reach gray-level 3 more quickly.

When gray-level is recorded in 6-bit, each pixel can display 64 (0-63) types of gray-level variations, therefore each pixel requires a 64-bit buffer capacity to store a previous gray-level data into the buffer. If utilized on a color display, three original colors: red, green, and blue are required to temporarily store the previous gray-level data, that is, 192-bit (64-bit*3) buffer capacity is utilized in the buffer. If gray-level is recorded at a higher bit rate, then more buffer capacity will be utilized to store the gray-level data into the buffer. For example, if gray-level is recorded at 8-bit, for a color display, then 768-bit (256*3) of buffer capacity is utilized in the buffer. Therefore, the prior art requires a large amount of memory in order to store the gray-level data of each pixel.

### SUMMARY OF INVENTION

The present invention provides a method of reducing the frame buffer size for driving a pixel to solve the above-mentioned problem.

The present invention relates to a method of driving a pixel, the method comprising the following steps: (a) converting a first color signal at a first color space of the pixel into a second color signal at a second color space, wherein memory capacity of the second color signal is less than the first color signal, (b) storing the second color signal into a memory cell, (c) reading and converting the second color signal from the memory cell into a first color signal, and (d) driving the pixel according to a first color signal and a target gray level.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a diagram of a conventional gray level lookup table.

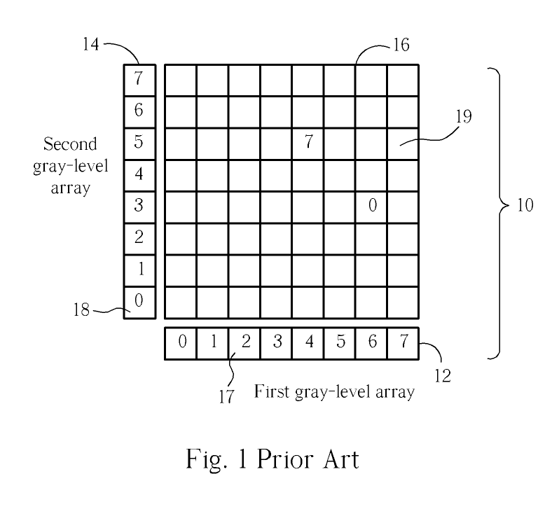

FIG. 2 illustrates a flowchart of driving a pixel.

FIG. 3 illustrates a graph of frame buffer size for each pixel at different YUV sampling formats.

### DETAILED DESCRIPTION

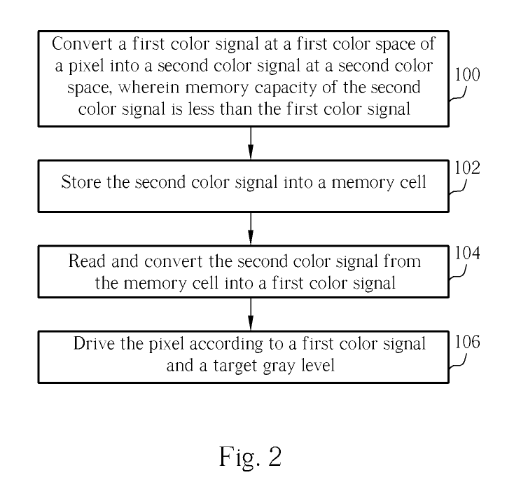

Please refer to FIG. 2. FIG. 2 illustrates a flowchart of driving a pixel. A display device can be a liquid crystal display (LCD), the method of the present invention is capable of reducing frame buffer size for driving a pixel, the method comprising the following steps:

Step 100: converting a first color signal at a first color space of a pixel into a second color signal at a second color space, wherein memory capacity of the second color signal is less than the first color signal;

Step 102: storing the second color signal into a memory cell;

Step 104: reading and converting the second color signal from the memory cell into a first color signal;

Step 106: driving the pixel according to a first color signal and a target gray level.

A detailed explanation will be given on the above-mentioned steps. The first color space of the present invention can be an RGB color space, the first color signal of step 100 can be a first RGB signal, the color signal of step 104 can be a second RGB signal, furthermore, the second color space of the above-mentioned steps can be a YUV color space and the second color signal can be a YUV signal. Firstly, a gray-level value figure of a first RGB signal of a previous frame data of the pixel is converted to a YUV signal, sampling method, after the conversion of the first RGB signal to the YUV signal, can be (4:1:1), (4:2:2), (4:2:0) or (2:1:1), which is set by compression of frame data required, while the greater the compression chosen, the smaller the storage size of the memory cell will be taken up by the sampled YUV signal, and a conversion relationship between the YUV signal and the first RGB signal is as follows:
Y=0.299R+0.587G+0.114B;
U=−0.148R−0.289G+0.437B;
V=0.615R−0.515G−0.1B

The display device will then temporarily store the YUV signal to the memory cell until a next frame data is inputted, then the YUV signal will be read and converted from the memory cell into a second RGB signal, wherein if the first RGB signal is converted into the YUV signal without any image compression process, then the second RGB converted from the YUV signal will still be equal to the first RGB, in doing so image distortion will not occur; however if the first RGB signal is converted into the YUV signal by other sampling methods, then the second RGB converted from the YUV signal will not be equal to the first RGB and image distortion may occur, depending on the compression of frame data set, but basically the degree of distortion is very small and will not affect the quality of the image frame. A conversion relationship between the second RGB signal and the YUV signal is as follows:
R=Y+1.140V;
G=Y−0.395U−0.581V;
B=Y+2.032U.

Finally, a pixel is driven according to the second RGB signal and a target gray-level, for example, when employing an electric field with strength E1, the liquid crystal molecule will turn to gray-level A1 in the corresponding second RGB signal, when employing an electric field with strength E2, the liquid crystal molecule will then turn to target gray-level A2 of a RGB signal in a next corresponding frame data, and when employing an electric field with strength E3, the liquid crystal molecule will turn to corresponding gray-level A3, where E1<E2<E3 and A1<A2<A3. When the pixel turns from gray-level A1 of the second RGB signal to target gray-level A2 of the RGB signal in the next corresponding frame data when the LCD panel changes the electric field strength from E1 to E2. If the pixel is not overdriven, it takes a delay time for the pixel to change from gray-level A1 to gray-level A2. However, if we want to shorten the transformation time of the pixel from gray-level A1 to gray-level A2, the LCD panel may change an original electric field strength E1 to an electric field strength E3, causing the liquid crystal molecule to change to the target gray-level A2 in a faster way. The overdriven transformation of the pixel is stopped once the gray-level of the pixel reaches A2. Therefore, the transformation of a pixel is sped up and the delay time of the transformation is reduced. The prior art overdrive technology utilizes a look up table (LUT) to store the needed overdrive gray-level value (A3) of each gray-level transformation to provide the electric field strength (E3) of the overdrive pixel.

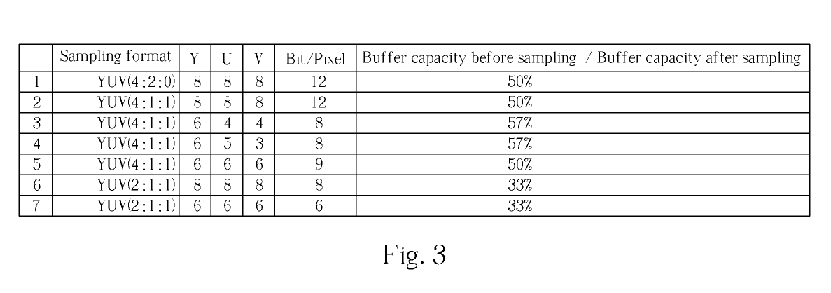

Please refer to FIG. 3. FIG. 3 illustrates a graph of the frame buffer capacity for each pixel at different YUV sampling formats. As shown in FIG. 3, when each Y, U, V of a YUV signal requires an 8-bit buffer capacity and the sampling method (4:2:0) is utilized (4 Y, 1 U, 1 V sampled in a pixel of 2*2 alignment), then after sampling the buffer capacity required by each pixel is 12 bit (8+8/4+8/4).

When each Y, U, V of YUV signal requires an 8-bit buffer size and the sampling method (4:1:1) is utilized (4 Y, 1 U, 1 V sampled in a pixel of 1*4 alignment), then after sampling the buffer capacity utilized by each pixel is 12 bit (8+8/4+8/4), which is 50% (12/(8+8+8)*100%) of buffer capacity utilized before the image sampling process.

Likewise, when each Y, U, V of YUV signal requires 6-bit, 4-bit, and 4-bit buffer capacity respectively and the sampling method (4:1:1) is utilized, then after sampling the buffer capacity utilized by each pixel is 8 bit (6+4/4+4/4), which is 57% (8/(6+4+4) *100%) of buffer capacity utilized before image sampling process.

When each Y, U, V of YUV signal requires a 6-bit, 5-bit, and 3-bit buffer capacity respectively and the sampling method (4:1:1) is utilized, after sampling, then the buffer capacity utilized by each pixel is 8 bit (6+5/4+3/4), which is 57% (8/(6+5+3)*100%) of buffer capacity utilized before the image sampling process. When each Y, U, V of YUV signal requires 6-bit, 6-bit, and 6-bit buffer capacity respectively and the sampling method (4:1:1) is utilized, then after sampling the buffer capacity utilized by each pixel is 9 bit (6+6/4+6/4), which is 50% (9/(6+6+6)*100%) of buffer capacity before the image sampling process. When each Y, U, V of YUV signal takes up 8-bit, 8-bit, and 8-bit buffer capacity respectively and the sampling method (2:1:1) is utilized (2 Y, 1 U, 1 V sampled in every 4 pixels), then after sampling the buffer capacity utilized by each pixel is 8 bit (8/2+8/4+8/4), which is 33% (8/(8+8+8)*100%) of buffer capacity utilized before the image sampling process. When each Y, U, V of YUV signal utilizes 6-bit, 6-bit, and 6-bit buffer capacity respectively and the sampling method (2:1:1) is utilized, then after sampling the buffer capacity utilized by each pixel is 6-bit (6/2+6/4+6/4), which is 33% (6/(6+6+6)*100%) of the buffer capacity utilized before the image sampling process. Other types of sampling methods create different methods of saving frame buffer size. Calculation formulae is similar to the above-mentioned, therefore will not be further mentioned. In conclusion, the method of the present invention can be applied to different YUV sampling methods to save frame buffer size of image data temporarily stored for each pixel. The scientifically proven present invention utilizes the method of converting the RGB signals to YUV signals and performing the method of signals sampling, basically the degree of distortion is minimal and will not affect the quality of the image.

Furthermore, the second color space of the present invention can be a YIQ color space and the second signal color of the above-mentioned steps can be a YIQ signal. A conversion relationship between the YIQ signal and the first RGB signal of step 100 is as follows:
Y=0.299R+0.587G+0.114B;
I=0.596R−0.275G−0.321B;
Q=0.212R−0.523G+0.311B.

A conversion relationship between the second RGB signal and the YIQ signal of step 104 is as follows:
R=Y+0.9561+0.621Q;
G=Y−0.2721−0.647Q;
B=Y−1.1071+1.704Q.

Otherwise, the second color space of the present invention can be a YCbCr color space and the second signal color of the above-mentioned steps can be a YCbCr signal. A conversion relationship between the YCbCr signal and the first RGB signal of step 100 is as follows:
Y=0.299R+0.587G+0.114B;
I=0.596R−0.275G−0.321B;
Q=0.212R−0.523G+0.311B.

A conversion relationship between the second RGB signal and the YCbCr signal of step 104 is as follows:
R=Y+((Cr−128)*1.4020);
G=Y−((Cb−128)*0.3441)−((Cr−128)*0.7139);
B=Y+((Cb−128)*1.7718).

Sampling methods generated by converting different color spaces create different methods of saving the frame buffer size. The calculation formulae are similar to the above-mentioned; therefore, it will not be further mentioned.

In comparison to the prior art, the method of the present invention of reducing frame buffer size for driving a pixel, as a first color signal at a first color space of a pixel is converted into a second color signal at a second color space to be sampled, wherein after sampled, memory capacity of the second color signal is less than the first color signal, after that the second color signal is stored into a memory, the method can effectively reduce frame buffer size of image data temporarily stored for each pixel, and the requirements for memory bandwidth can be reduced therefore reducing the cost of producing LCD panels.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of driving a pixel, the method comprising the following steps:
(a) converting a first color signal at a first color space of the pixel into a second color signal at a second color space, wherein memory capacity of the second color signal is less than the first color signal;
(b) storing the second color signal into a memory cell;
(c) reading and converting the second color signal from the memory cell into a first color signal; and
(d) driving the pixel according to a first color signal and a target gray level.

2. The method of claim 1 further comprising reducing an electric field strength of the driving the pixel when the gray level of the pixel reaches the target gray level.

3. The method of claim 2 wherein step (d) is a method of utilizing overdrive of the gray level of the pixel.

4. The method of claim 3 wherein step (d) provides overdriving the electric field strength of the pixel according to a pair of look up tables (LUTs).

5. The method of claim 1 wherein the first color space is an RGB color space, the first color signal is an RGB signal, the second color space is a YUV color space, and the second color signal is a YUV signal.

6. The method of claim 5 wherein step (a) converts the RBG signal of the pixel into the YUV signal according to a sampling method of (4:1:1).

7. The method of claim 5 wherein step (a) converts the RBG signal of the pixel into the YUV signal according to a sampling method of (4:2:0).

8. The method of claim 5 wherein step (a) converts the RBG signal of the pixel into the YUV signal according to a sampling method of (2:1:1).

9. The method of claim 5 wherein step (a) utilizes a conversion relationship between the YUV signal and the RGB signal, the conversion relationship being Y=0.299R+0.587G+0.114B, U=−0.148R−0.289G+0.437B, V=0.615R−0.515G−0.1B.

10. The method of claim 5 wherein step (c) utilizes a conversion relationship between the RGB signal and the YUV signal, the conversion relationship being R=Y+1.140V, G=Y−0.395U−0.581V, B=Y+2.032U.

11. The method of claim 1 wherein the first color space is an RGB color space, the first color signal is an RGB signal, the second color space is a YIQ color space, and the second color signal is a YIQ signal.

12. The method of claim 11 wherein step (a) utilizes a conversion relationship between the YIQ signal and the RGB signal, the conversion relationship being Y=0.299R+0.587G+0.114B, I=0.596R−0.275G−0.321B, Q=0.212R−0.523G+0.311B.

13. The method of claim 11 wherein step (c) utilizes a conversion relationship between the RGB signal and the YIQ signal, the conversion relationship being R=Y+0.9561+0.621Q, G=Y−0.2721−0.647Q, B=Y−1.1 071+1.704Q.

14. The method of claim 1 wherein the first color space is an RGB color space, the first color signal is an RGB signal, the second color space is a YCbCr color space, and the second color signal is a YCbCr signal.

15. The method of claim 14 wherein step (a) utilizes a conversion relationship between the YCbCr signal and the RGB signal, the conversion relationship being Y=0.299R+0.587G+0.114B, I=0.596R−0.275G−0.321B, Q=0.212R−0.523G+0.311B.

16. The method of claim 14 wherein step (c) utilizes a conversion relationship between the RGB signal and the YCbCr signal, the conversion relationship being R=Y+((Cr−128)*1.4020), G=Y−((Cb−128)*0.3441)−((Cr−128)*0.7139), B=Y+((Cb−128) *1.7718).
